(19) United States
(12) Patent Application Publication
(10) Pub. No.: US 2025/0024773 A1
(43) Pub. Date: Jan. 23, 2025

(54) WATER AND SOIL RESOURCE COMPREHENSIVE IMPROVEMENT METHOD FOR LOESS HILLY AND GULLY REGION CHANNELS

(71) Applicant: Institute of Land Engineering and Technology, Shaanxi Provincial Land Engineering Construction Group, Xi 'an, Shaanxi (CN)

(72) Inventors: Jichang HAN, Xi 'an, Shaanxi (CN); Zhe LIU, Xi 'an, Shaanxi (CN); Huanyuan WANG, Xi 'an, Shaanxi (CN); Zenghui SUN, Xi 'an, Shaanxi (CN); Tianqing CHEN, Xi 'an, Shaanxi (CN); Na LEI, Xi 'an, Shaanxi (CN)

(21) Appl. No.: 18/714,437

(22) PCT Filed: Aug. 29, 2023
(86) PCT No.: PCT/CN2023/115574

§ 371 Date: May 29, 2024

(30) Foreign Application Priority Data
Sep. 2, 2022 (CN) 202211073483.9

(51) Int. Cl. A01B 79/00; A01B 79/02; E02B 11/00; E02B 13/02

(52) U.S. Cl. CPC A01B 79/005; A01B 79/02; E02B 11/005; E02B 13/02

(57) ABSTRACT

The present invention relates to the technical field of land engineering, and relates to a water and soil resource comprehensive improvement method for loess hilly and gully region channels. The method comprises: (1) soil layer general survey: performing soil layer thickness survey and soil nutrition content measurement; (2) soil body reconstruction: on the basis of soil layer general survey data, selecting a soil body construction mode, and performing soil body profile reconstruction, soil body nutrition reconstruction and field parcel arrangement; and (3) constructing a water resource regulation and control system for the loess hilly and gully region channels. According to the present invention, investigation and survey are performed firstly, then treatment is performed, water and soil are treated simultaneously, and steps are coordinated, so that ecological treatment of the loess hilly and gully region channels is finally completed, and comprehensive improvement of water and soil resources is achieved. The present invention ensures mechanical cultivation of the region after the improvement, effectively increases the area of the irrigable land and the area of the non-irrigated land, effectively improves the farmland quality and the grain yield, and effectively reduces the soil erosion amount of the channels.

### BACKGROUND

### 1. Technical Field

The present disclosure generally relates to the field of soil engineering technologies, relates to treatment of gully control and land reclamation projects, and especially relates to a water and soil resource comprehensive improvement method for loess hilly and gully region channels.

### 2. Description of Related Art

China is a mountainous country, with mountainous areas accounting for about 70% of land areas thereof, and about 40% population still lives in mountainous areas. Because a generally backward economic level, a high intensity of agricultural development and a widespread unreasonable land usage are occurred in the mountainous areas, soil erosion is extremely serious, thereby leading to further reduction of cultivation land resources. In addition, a comprehensive implementation of returning farmlands to forests has further reduced the cultivation field parcel resources in the mountainous areas, and a contradiction between people and lands is extremely prominent. Gully control and land reclamation refers that an modern mechanical equipment is used to level and regulate valleys and inter valley areas, construct terraced fields (lands), and supplement field roads and small-scale water conservancy measures etc., that is a process of converting gully lands that are previously unusable into large-scale, high-quality farmlands suitable for modern scale agricultures.

At present, the gully control and land reclamation includes a Yan'an mode of the Loess Plateau, a purple soil hilly region mode, a mudslide control and utilization of tidal flats, a Yuan'mou “Pinggou Jianyuan” mode of the dry and hot river valley, and the Ning'nan mode of the dry and hot river valley. A Chinese patent No. CN 114032874 A discloses a gully land improvement structure and a method for gully control and land reclamation in the Loess Plateau, including shallow soil of original channels, a filled loess foundation and farmlands that are arranged from bottom to top on a bedrock surface of the original channels in the channel soil to be treated. The filled loess foundation includes a bottom bearing layer, a middle transition layer, and a top filter layer arranged from bottom to top thereof, and a compaction degree of each of the bottom bearing layer, the middle transition layer and the top filter layer gradually decreases. The present disclosure changes a compaction degree of a vertical filling material in the filling engineering, to enable different filling soil layers to achieve different functions, thereby having triple functions of bearing weights, preventing and controlling collapses and filtering and draining water. It can effectively solve a problem of soil filling in the gully control and land reclamation of the Loess Plateau, ensure a safety and usage of ditch structures to be conveniently promoted and used. Another Chinese patent No. CN114000475 A discloses a farmland soil drainage system for gully control and land reclamation in the Loess Plateau and a construction method thereof, the farmland soil drainage system including farmland drainage channels, a plurality of reservoirs, drainage blind ditches and side slope drainage structures. The farmland drainage channels are set on both sides of the top of the ditch farmland and located at the bottom of an excavation slope along an extension direction of an original valley terrain; the plurality of reservoirs are spaced at the top of the both sides of the ditch farmland, and adjacent reservoirs are connected by the farmland drainage channel; the drainage blind ditches are set at the bottom of the filled loess foundation and arranged along an underground extension direction of the original valley; the side slope drainage structures are arranged on the excavation slope, and a bottom end of the side slope drainage structure is connected to the farmland drainage channel. The present disclosure can effectively solve the problem of farmland soil drainage in channels of gully control and land reclamation in the Loess Plateau, avoid water accumulation in valleys and farmlands; at the same time, the present disclosure can effectively ensure the safety and daily irrigation usage for farmlands in channels of gully control and land reclamation, have a simple structure, low construction difficulty, a low cost, and been easy to be promoted and used. The above two patents only proposed the land improvement structure and the farmland drainage system, which fails to comprehensively and systematically solve the ecological management of gullies in the loess hilly and gully region channels, to achieve comprehensive improvement of soil and water resources.

At present, results of various modes for gully control and land reclamation are shown that they have effectively increased cultivation land areas, improved agricultural production conditions, increased grain yields, increased vegetation coverage, and formed a regional microclimate. However, during the implementation process, problems such as high groundwater level in channels, poor irrigation and drainage in farmlands, frequent secondary salinization and alkalization, and slope landslides and collapses have also occurred, which seriously affects social, economic and ecological benefits of gully control and land reclamation projects.

### SUMMARY

The technical problems to be solved: in view of the shortcomings of the related art, the present disclosure provides a water and soil resource comprehensive improvement method for loess hilly and gully region channels which can solve problems that low soil fertility of channels, and disasters of drought, waterlogging, salinization and soil and water loss are frequently occurred, and the method is simple, easy to be operated and has clear steps, is correct, has a reasonable design and a good result, and can effectively comprehensively improve the soil and water resources for loess hilly and gully region channels.

In an aspect, a water and soil resource comprehensive improvement method for loess hilly and gully region channels according to an embodiment of the present disclosure includes: (1) soil layer general survey: performing soil layer thickness survey and soil nutrition content measurement; (2) soil body reconstruction: on the basis of soil layer general survey data, selecting a soil body construction mode, and performing soil body profile reconstruction, soil body nutrition reconstruction and field parcel arrangement; and (3) constructing a water resource regulation and control system for the loess hilly and gully region channels.

Furthermore, in the water and soil resource comprehensive improvement method for loess hilly and gully region channels of the present disclosure, the step of performing soil layer thickness survey includes: measuring the soil layer thickness of a typical area in areas to be rectified, forming a calibration equation, and then measuring the soil layer thickness of other areas, and using the calibration equation for calibration.

The soil layer thickness is a key factor that needs to be considered in an earlier stage of general survey and a later stage of soil body organic reconstruction for land remediation of loess channels. If there is a significant difference of the soil layer thickness in terraced fields at the same level, dynamic effects are easily occurred by the slope of the ditches and a ditch water system, especially after continuous rainfall or long-term drought, which is easy to cause uneven distribution of water resources within the same field parcel, thereby leading to significant differences in crop growth. When performing large-scale soil layer general survey, constructing calibration equations for performing the soil layer thickness measurement can effectively save engineering costs and improve work efficiency, and performing calibration can ensure accuracy of general survey results.

A survey method of the soil layer thickness adopts one of a soil drilling method and a ground penetrating radar. The soil drilling method mainly involves an actual measurement, selecting five points on each measurement line to drill soil vertically downwards until it touches a parental material, a mother rock or a groundwater surface, and recording a depth of the soil layer at this time. An average value of depths of the soil layer on these five points represents an average soil layer thickness of the field parcel. A measurement result of the soil drilling method is very accurate, but such method is time-consuming and laborious, which is suitable for applications on a small range, and has a certain degree of destructive effect on soil structures.

Furthermore, in the water and soil resource comprehensive improvement method for loess hilly and gully region channels of the present disclosure, the step of selecting the soil body construction mode is based on a comparison between a minimum value of the soil layer thickness that is measured at each detection point in the areas to be rectified and a maximum elevation difference between each of detection points, to select a corresponding soil body construction mode; the corresponding soil body construction mode selected from one of the following modes: (1) if the maximum elevation difference between each of the detection points in the areas to be rectified is less than the minimum value of the soil layer thickness that is measured at each detection point, performing the soil layer thickness reconstruction and land leveling on rectification areas directly; wherein the soil layer thickness isn't less than 30 cm, and a slope ratio is less than or equal to 5/1000; (2) if the maximum elevation difference between each of the detection points in the areas to be rectified is greater than the minimum value of the soil layer thickness that is measured at each detection point, under a principle of performing excavation and filling on earthwork balance, stripping topsoil and then placing the topsoil that has been stripped in a centralized manner, after the soil leveling meets a specification, backfilling the topsoil according to a design elevation, optimizing the soil layer thickness and a slope; wherein the slope ratio of the land that has been rectified is less than or equal to 5/1000, and the soil layer thickness is 50-80 cm; and (3) if the elevation difference between each of the detection points in the areas to be rectified is greater than 4 m or the soil layer thickness of the detection points is lower than the elevation difference of a small number of detection points, based on a detection result of the soil layer thickness in an early stage, performing field parcel distribution on the area that has been rectified, with a principle of facilitating mechanical cultivation and increasing an effective cultivation land area, based on terrain and topography, planning to shape the field parcels to be approximately regular squares to ensure engineering requirements of a construction thickness and the slope, as well as growth needs of crops.

Furthermore, in the water and soil resource comprehensive improvement method for loess hilly and gully region channels of the present disclosure, the step of performing the soil body profile reconstruction is performing thickness remediation on the areas with uneven soil thickness in the field parcels; the step of performing the soil body nutrition reconstruction including: detecting a soil nutrient index content of a cultivation layer, clarifying soil nutrient deficiency indicators, calculating a soil nutrient application amount of the cultivation layer, ensuring that the cultivation layer meets requirements of soil nutrient quality control, or performing improvement of the soil body nutrient reconstruction.

According to results of the general survey, in order to maintain sustainability of soil water and fertilizer conditions in the cultivation layer, it is needs to perform thickness improvement on areas with uneven soil layers in the field parcel. During the rectification process, a topsoil layer with a thickness of 25 cm is stripped off and stored separately inside the field parcel. Then, the soil thickness is increased and treated according to a design soil thickness, after performing soil filling is completed, the topsoil that has been stripped is backfilled to maintain the soil quality of the cultivation layer to be unchanged. When backfilling the soil, in order to ensure structural stability of the soil bodies and fertilizer and water retention characteristics of soil layers, the soil layer thickness should not be less than 50 cm, mechanical methods and animal methods are used to loosen the soil cultivation layer, and a soil bulk density of each layer is reasonably controlled to build a good soil layer structure with upper looseness and lower tightness thereof.

Furthermore, in the water and soil resource comprehensive improvement method for loess hilly and gully region channels of the present disclosure, calculation of the soil nutrient application amount of the cultivation layer is shown in equation (1):

$$Y = ( X \times M - S \times 2.25 \times T ) / F ; \qquad ( 1 )$$

wherein in the equation (1), Y is the nutrient application amount, kg/hm²; X is a nutrient absorption per unit yield of crops, kg/100 kg; M is a target yield, 100 kg/hm²; S is a measured value of the soil nutrient content, mg/kg; 2.25 is a conversion coefficient for converting soil nutrient of the cultivation layer to 1 hm² of soil nutrient content; T is a correction coefficient, that is, a soil nutrient utilization efficiency; and F is a seasonal utilization rate of nutrients.

Furthermore, in the water and soil resource comprehensive improvement method for loess hilly and gully region channels of the present disclosure, requirements for various nutrient indicators of the cultivation layer soil are as follows: an organic matter/(g/kg)≥5, a total nitrogen/(g/kg)≥0.5, an alkali hydrolyzed nitrogen/(mg/kg)≥60, an available phosphorus/(mg/kg)≥2, and an available potassium/(mg/kg)≥50.

The cultivation layer that has been performed soil profile reconstruction should also meet requirements of controlling soil nutrient quality, for those that do not meet the above requirements, conditioner such as organic fertilizers, chemical fertilizers and microbial agents etc., should be added for performing soil nutrient reconstruction and improvement, and an appropriate application method is selected based on types of the conditioners.

Furthermore, in the water and soil resource comprehensive improvement method for loess hilly and gully region channels of the present disclosure, the step of performing field parcel arrangement includes: land leveling units are divided into two types of strip fields and terraced fields, the trip fields including paddy fields; wherein each control area of the strip field is 0.25 hm²-1.00 hm² to conveniently be cultivated by large machinery equipments; the terraced fields are built on sloping farmlands below a slope of 15°, with an area of each terraced field being controlled between 0.15 hm²-3.50 hm², and a minimum area of the terraced field is not less than 0.03 hm²; the soil layer thickness of the cultivation field parcels in the terraced fields greater than 30 cm; after the cultivation field parcel within the terraced fields is leveled, retaining about 1 meter away from an edge of the field, and a reverse slope of 10° to obtain a high outside and a low inside thereof; and the cultivation field parcels of the paddy fields are internally arranged with grid fields, with a length of 30 m-120 m and a width of 20 m-40 m; a field ridge bounded between the grid fields, with a height of 30 cm and a width of 20 cm at the top of the field ridge; a height difference of an inner field surface in the grid field less than ±3 cm, and the soil layer thickness greater than 50 cm.

The field parcels should be divided into sections such as field roads, production roads, ridges and drainage ditches, planning the field parcels to be approximately rectangular, for local corner areas, the field parcels should be determined based on actual terrains. The field parcel layout takes into account various terrains such as terraces, ditches and slopes, and large bends taking advantage of situations and small bends taking advantage of straightness are for easy cultivation.

Furthermore, in the water and soil resource comprehensive improvement method for loess hilly and gully region channels of the present disclosure, the water resource regulation and control system includes constructing a detention reservoir, an intercepting drain, a flood discharge ditch and a dual-purpose irrigation and drainage canal; the detention reservoir configured to divert water into the dual-purpose irrigation and drainage canal, the intercepting drain configured to replenish water for soil to meet agricultural water needs during drought; water from the detention reservoir discharged into a flood discharge ditch, the water from the dual-purpose irrigation and drainage canal discharged into the intercepting drain, and the water from the intercepting drain discharged into the flood discharge ditch to lower a groundwater level during flooding.

Furthermore, in the water and soil resource comprehensive improvement method for loess hilly and gully region channels of the present disclosure, a lateral canal of the dual-purpose irrigation and drainage canal is subjected to perform continuous irrigation, and a design flow rate is calculated according to an equation (2):

$$Q = {q}_{s} \cdot {A}_{S} \qquad ( 2 )$$

wherein in the equation (2), Q is a design flow rate of a trunk canal (m³/s), qₛ is a design irrigation modulus, and Aₛ is an irrigation area controlled by the trunk canal (hm²); and wherein
a design flow rate of a field ditch of the dual-purpose irrigation and drainage canal is calculated according to an equation (3):

$$Q = amAN / 86400 \cdot T \cdot η \qquad ( 3 )$$

wherein in the equation (3), Q represents the design flow rate of the field ditch (m³/s), a represents a proportion of a crop planting area (%), m represents an irrigation quota required for a critical growth period of crops (m³/mu), A represents an irrigation area controlled by the field ditch (mu), N represents a number of irrigation groups of the field ditch, T represents a duration time of performing crop irrigation, and n represents a water utilization coefficient of the field ditch.

In another aspect, the water and soil resource comprehensive improvement method for loess hilly and gully region channels above mentioned is applied to an application of ecological management of loess hilly and gully regions, wherein the ecological management includes: increasing areas of irrigated lands, areas of non-irrigated lands, farmland quality and a grain yield, preventing and controlling soil salinization and reducing a soil erosion amount.

The present disclosure provides the advantages as below:
the present disclosure proposes to first perform general survey on soil bodies of the channels, and perform soil body profile reconstruction and soil body nutrition reconstruction, and then perform a non-power regulation irrigation technology on farmlands by using interflow of the channels in the gully control and land reclamation, furthermore, by implementing comprehensive irrigation and drainage measures such as detention reservoirs, flood discharge ditches, intercepting drains and dual-purpose irrigation and drainage canals, to improve the quality of farmlands in the channels and achieve joint remediation of surface water, interflow and groundwater, so that a comprehensive regulation engineering mode for water and soil resources of the channels in the Loess Plateau is formed, which has significantly improved a utilization rate of water resources in the channels, established high standard farmlands and an efficient utilization technology system, thereby achieving coordinated development of ecological environment construction and economic and social development in the Loess Plateau, and providing a new idea for the comprehensive improvement of water and soil resources for loess hilly and gully region channels.

### BRIEF DESCRIPTION OF THE DRAWINGS

FIG. 1 is a schematic flowchart of a water and soil resource comprehensive improvement method for loess hilly and gully region channels in accordance with an embodiment of the present disclosure.

FIG. 2 is an image schematic view of a soil layer of Nanniwan gully detected by a ground penetrating radar; (a) is an image schematic view of a soil layer of a non-irrigated land, and (b) is an image schematic view of a soil layer of a paddy field.

FIG. 3 is a cross-sectional schematic view of soil layer reconstruction.

FIG. 4 is a schematic view of land leveling and field division in a typical region of Jiulongquan gully in Nanniwan Town. (a) is a schematic view of general survey before performing soil reconstruction, and (b) is a schematic view of field parcel layout after performing soil reconstruction.

FIG. 5 is a location schematic view of an intercepting drain; wherein the element labels shown as below: 1 terraced field, 2 flood drainage ditch, 3 intercepting drain.

FIG. 6 is a cross-sectional schematic view of the intercepting drain; wherein the element labels shown as below: 4 hardened roadbed, 5 soil boundary of the intercepting drain, 6 accumulation water in the intercepting drain.

FIG. 7 is a cross-sectional schematic view of a flood drainage ditch.

FIG. 8 is a schematic view of an irrigation and drainage canal and a water control valve. (a) is a top view of the irrigation and drainage canal, (b) is a longitudinal cross-sectional view of the irrigation and drainage canal, and (c) is a cross-sectional view of the water control valve; wherein the element labels shown as below: 1 inlet gate, 2 outlet gate, 3 regulating gate, 4 steel concrete cover plate, 5 angle steel, 6 valve pulling ring.

FIG. 9 is an operation schematic view of the water and soil resource comprehensive improvement method for loess hilly and gully region channels; wherein the element labels shown as below: \textcircled{A} flood drainage ditch, \textcircled{B} integrated irrigation and drainage canal, \textcircled{C} intercepting drain, □ steel concrete cover plate.

FIG. 10 is a schematic view of a comprehensive regulation and control operation mode of a non-power regulation irrigation.

### DETAILED DESCRIPTION

In order to thorough understand of the subject matter of the present disclosure by one of ordinary skill in the related art and implement the present disclosure, the following will further explain the present disclosure in conjunction with specific embodiments, however, the cited embodiments are not intended to limit the present disclosure.

Experimental methods and detection methods described in the following embodiments are conventional methods, unless otherwise specified; experimental supplies and raw materials can be purchased in the market, unless otherwise specified.

### Embodiments

An embodiment of the present disclosure provides a practical process and an application effect of the water and soil resource comprehensive improvement method for loess hilly and gully region channels which is used in the Yangwangou land improvement project in Nanniwan Town, Baota District, Yan'an City.

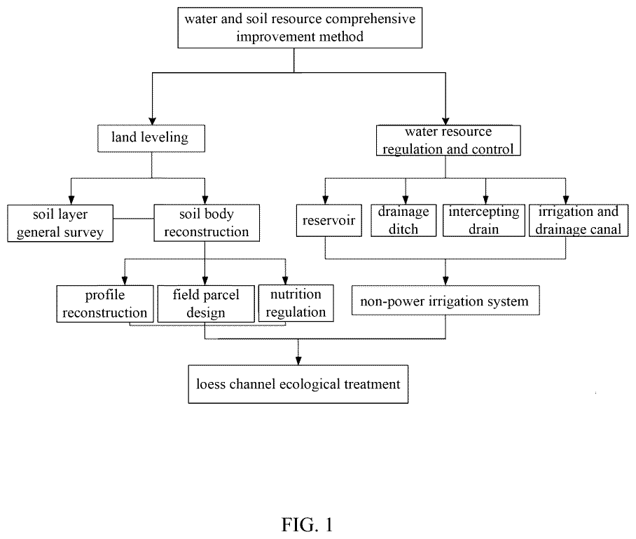

The above project area belongs to the loess hilly and gully region, due to erosion of branched river systems, the terrain is characterized by crisscrossing gullies and undulating ridges and hills, with the Loess Ridge hilly being a main feature. A northern part of the project area is a hilly and gully area of Maoliang, a southern part is a hilly and gully area of Liangmao, and a southeastern part is the loess plateau area. A climate type belongs to a plateau continental warm temperate semi-arid climate, with dry and windy in spring and hot and rainy in summer. An annual average temperature ranges from 7.7° C. to 10.6° C. An average temperature in January is −6.7° C., an average temperature in July is 22.9° C., the extreme highest temperature is 39.7° C., and the extreme lowest temperature is −25.4° C. An annual sunshine is 2445 hours, an annual precipitation is 450 mm-650 mm, and a frost free period is 155-188 days. According to a long-term general survey and research, the soil types in the remediation project area are mainly yellow soil and brown soil, due to severe erosion of valleys and slopes over a long period, gravity erosion of the slopes is active, so that collapse and landslides are prone to be occurred, and the ecological environment is fragile. Corns, millets and rice are main crops grown locally. According to a structure schematic view of the water and soil resource comprehensive improvement method for loess hilly and gully region channels as shown in FIG. 1, the comprehensive improvement of soil and water resources in the project area is performed.

### (1) Soil Layer General Survey

The soil layer thickness is a key factor that needs to be considered in an earlier stage of general survey and a later stage of soil body organic reconstruction for land remediation of loess channels. If there is a significant difference of the soil layer thickness in terraced fields at the same level, dynamic effects are easily occurred by the slope of the ditches and a ditch water system, especially after continuous rainfall or long-term drought, which is easy to cause uneven distribution of water resources within the same field parcel, thereby leading to significant differences in crop growth.

In order to save engineering costs and improve work efficiency, when performing large-scale soil layer general survey, typical areas can be selected to measure the soil layer thickness of the remediation area by using methods such as the soil drilling method and the ground penetrating radar, so as to form calibration equations; and then, ground penetrating radar is used to measure the soil layer thickness of other areas, and calibration equations is used to perform calibration for ensuring accuracy of the general survey results. A specific process is as follows:
1. the soil drilling method: the soil drilling method mainly involves an actual measurement, selecting five points on each measurement line to drill soil vertically downwards until it touches a parental material, a mother rock or a groundwater surface, and recording a depth of the soil layer at this time. An average value of depths of the soil layer on these five points represents an average soil layer thickness of the field parcel. A measurement result of the soil drilling method is very accurate, but such method is time-consuming and laborious, which is suitable for applications on a small range, and has a certain degree of destructive effect on soil structures.
2. the ground penetrating radar: the Seeker SPR ground penetrating radar produced by US Radar company is used in the experiment, with an antenna frequency of 500 MHz; under good geological conditions, a detection depth can reach 16 feet (4.8 m). Data acquisition software is Seeker SPR Acquisition Software, and data interpretation software is Reflexw Software.

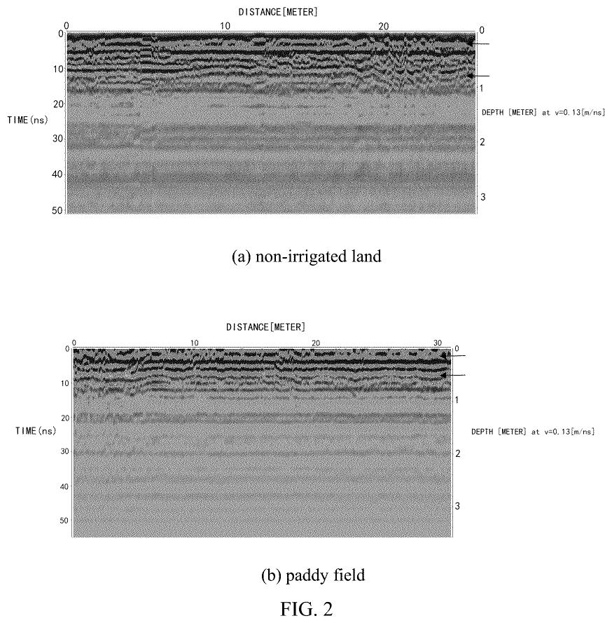

Selecting five representative paddy fields and corn fields as sampling points in the Jiulongquan gully land improvement project in Nanniwan Town, Yan'an City, that is the typical area of loess channels, and recording coordinates of each sampling point by using a high-precision GPS. In order to ensure that test results are representative, measurements are taken along diagonal directions of each field parcel. During the measurement process, the bottom of an antenna is always in good contact with the ground, and a movement rate is maintained at about 1 m/s, to avoid obstacles on measurement lines, and a length of each measurement line is 30 m-50 m.
3. Detection result: taking one of the corn fields and the paddy fields as examples, an image view of the ground penetrating radar is shown in FIG. 2. It can be seen from FIG. 2 that an interface between the soil and the rock is more obvious, depths of soil at different positions of the measurement line can be directly determined from FIG. 2. A line with a top dark color and a line with a significant change of a bottom color respectively represent a top interface of the radar image and a bottom interface of the radar image, a distance between the two lines is an average soil layer thickness of the field parcel.

### (2) Soil Body Reconstruction

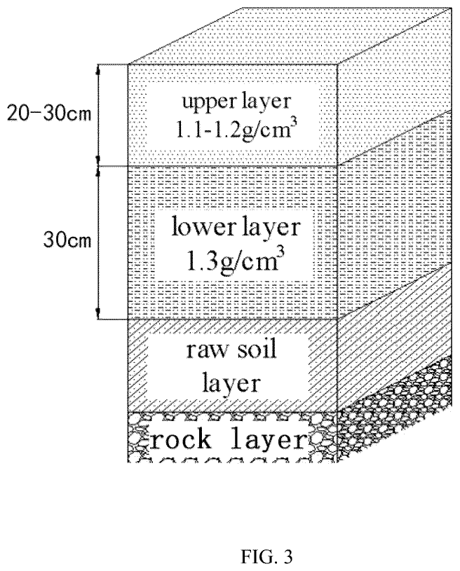

During implementing the project, in conjunction with remote sensing image technologies and GPS-RTK elevation measurement technologies etc., based on the soil layer thickness, a range, a terrain and elevation changes in the remediation area, and according to a comparison between a minimum value of the soil layer thickness that is measured at each detection point in the remediation area and a maximum elevation difference between each of detection points, selecting an appropriate soil body construction mode.
1) if the maximum elevation difference between the detection points in the areas that are rectified is less than the minimum value of the soil layer thickness that is measured at each detection point, performing the soil layer thickness reconstruction and land leveling on rectification areas directly; wherein the soil layer thickness isn't less than 30 cm, and a slope ratio is less than or equal to 5/1000.
2) if the maximum elevation difference between the detection points in the areas that are rectified is greater than the minimum value of the soil layer thickness that is measured at each detection point, under a principle of performing excavation and filling on earthwork balance, stripping topsoil and then placing the topsoil that has been stripped in a centralized manner, after the soil leveling meets a specification, backfilling the topsoil according to a design elevation, optimizing the soil layer thickness and a slope; wherein the slope ratio of the land that has been rectified is less than or equal to 5/1000, and the soil layer thickness is generally 50-80 cm.
3) if the elevation difference between each of the detection points in the areas that are rectified is greater than 4 m, based on a result that has been detected, performing field parcel distribution on the area that has been rectified according to local conditions, with a principle of facilitating mechanical cultivation and increasing an effective cultivation land area, taking into account various terrains and topographies comprehensively, planning to shape the field parcels to be approximately regular squares to ensure engineering requirements of a construction thickness and the slope, and meet growth needs of crops while reducing costs.
1. soil body profile reconstruction: according to the general survey results, in order to maintain sustainability of soil water and fertilizer conditions in the cultivation layer, it is needs to perform thickness improvement on areas with uneven soil layers in the field parcels. During the rectification process, a topsoil layer with a thickness of 25 cm is stripped off and stored separately inside the field parcel. Then, the soil thickness is increased and treated according to a design soil thickness, after performing soil filling is completed, the topsoil that has been stripped is backfilled to maintain the soil quality of the cultivation layer to be unchanged. When backfilling the soil, in order to ensure structural stability of soil bodies and fertilizer and water retention characteristics of the soil bodies, the soil layer thickness should not be less than 50 cm, mechanical methods and animal methods are used to loosen the soil cultivation layer, and a soil bulk density of each layer is reasonably controlled to build a good soil layer structure with upper looseness and lower tightness thereof. The structure is shown in FIG. 3.
2. soil body nutrition reconstruction: the cultivation layer after performing soil body profile reconstruction also meets requirements of soil nutrient quality control. For those that do not meet the above requirements, conditioner such as organic fertilizers, chemical fertilizers and microbial agents etc., should be added for performing soil nutrient reconstruction and improvement, and an appropriate application method is selected based on types of the conditioners. On the basis of testing soil and performing formula fertilization, detecting a soil nutrient index content in a laboratory to clarify indicators of soil nutrient abundance and deficiency, and focus on and precisely adjust soil physical and chemical properties, a comprehensive and rapid fertilization technology of “soil diagnosis+organic and inorganic fertilizers+trace elements+microbial agents” is proposed. Taking organic materials such as sheep manure and pig manure with high organic matter contents in the local area as the main conditioners, coupled with fertilizers containing large amounts of elements such as nitrogen, phosphorus and potassium, appropriately using straw and green manure returning to the field for soil nutrient improvement reconstruction, supplementing with a rapid fertilization comprehensive technology that is combined with medium and trace elements such as calcium and magnesium, and organic and inorganic microbial agents of coal based microbial agents that are independently developed, to improve organic matter contents of soil, accelerate soil maturation and self recovery; adopting a soil sustainable development mode that combines planting and breeding to achieve rapid improvement of soil quality and efficient utilization of resources in the loess plateau channels.

A calculation of the soil nutrient application amount of the cultivation layer is shown in equation (1):

$$Y = ( X \times M - S \times 2.25 \times T ) / F \qquad ( 1 )$$

wherein in the equation (1),
Y is the nutrient application amount, kg/hm²;
X is a nutrient absorption per unit yield of crops, kg/100 kg;
M is a target yield, 100 kg/hm²;
S is a measured value of the soil nutrient content, mg/kg;
2.25 is a conversion coefficient for converting soil nutrient of the cultivation layer to 1 hm² of soil nutrient content;
T is a correction coefficient, that is, a soil nutrient utilization efficiency; and
F is a seasonal utilization rate of nutrients.

A design requirement of a biological nutrition reconstruction in the cultivation layer is shown in Table 1.

TABLE 1
design requirement of a biological nutrition
reconstruction in the cultivation layer

| item | index | detection method |
|---|---|---|
| organic matter/(g/kg) | ≥5 | NY/T 1121.6-2006 |
| total nitrogen/(g/kg) | ≥0.5 | NY/T 53-1987 |
| alkali hydrolyzed | ≥60 | LY/T 1228-2015 |
| nitrogen/(mg/kg) | | |
| available phosphorus/(mg/kg) | ≥2 | NY/T 1121.7-2014 |
| available potassium/(mg/kg) | ≥50 | NY/T 889-2004 |

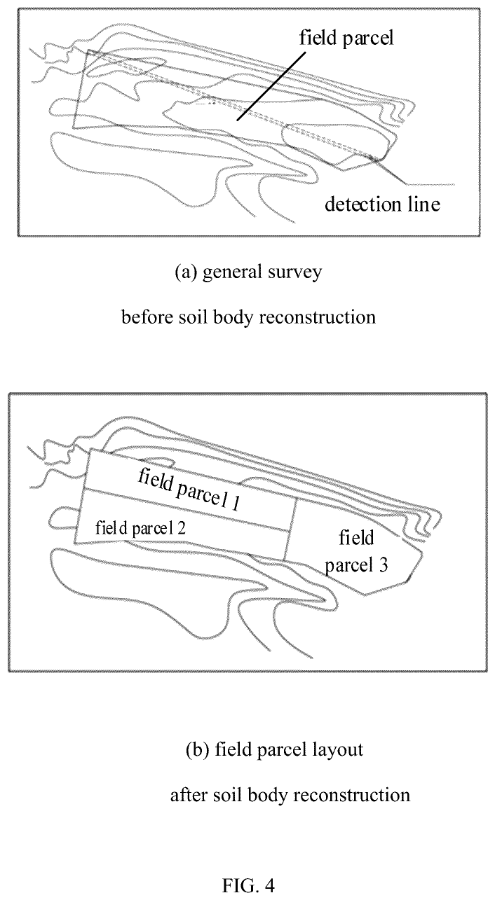

3. field parcel arrangement: the field parcels should be divided into sections such as field roads, production roads, ridges and drainage ditches, planning the field parcels to be approximately rectangular, for local corner areas, the field parcels should be determined based on actual terrains. The field parcel layout takes into account various terrains such as terraces, ditches and slopes, and large bends taking advantage of situations and small bends taking advantage of straightness are for easy cultivation. Land leveling units are divided into two types of strip fields (including paddy fields) and terraced fields. Each control area of the strip field is 0.25 hm²-1.00 hm² to conveniently be cultivated by large machinery equipments; the terraced fields are built on sloping farmlands below a slope of 15°, with an area of each terraced field being controlled between 0.15 hm²-3.50 hm², and a minimum area of the terraced field is not less than 0.03 hm². The soil layer thickness of the cultivation field parcels should be easy to be cultivated, with good water and fertilizer retention ability, suitable for crop growth, and the soil layer thickness should be greater than 30 cm. After the cultivation field parcel within the terraced fields is leveled, retaining about 1 meter away from an edge of the field, and a reverse slope of 10° to obtain a high outside and a low inside thereof. The cultivation field parcels of the paddy fields are internally arranged with grid fields, with a length of 30 m-120 m and a width of 20 m-40 m; a field ridge bounded between the grid fields, with a height of 30 cm and a width of 20 cm at the top of the field ridge; a height difference of an inner field surface in the grid field less than ±3 cm, and the soil layer thickness greater than 50 cm. According to the general survey results, under a condition of meeting the soil layer thickness, combining with the above field layout principle to perform field parcel distribution, the typical area of Jiulongquan gully in Nanniwan Town is divided into three field parcels, specifically as shown in FIG. 4.

### (3) Constructing a Water Resource Regulation and Control System for the Loess Hilly and Gully Region Channels

Constructing a water resource regulation and control system for the loess hilly and gully region channels, and designing a non-power regulation and irrigation technical system for interflow of the channels. The technical system mainly includes the following contents:

### 1. Detention Reservoir

During the construction process, the reservoir is an important water source project and a basic guarantee for ensuring agricultural production water supply. According to a principle of improving the utilization efficiency of water and soil resources, the reservoirs near edges of farmlands are excavated to avoid concentrated rainfall from damaging the farmlands during floods, and use water that is stored in the reservoirs to irrigate the farmlands during drought, so that the farmlands are subjected to flood discharge and drought irrigation. A specific implementation is as follows:
1) reservoirs should be built in narrow crevices of mountains or rivers as much as possible.
2) a design of the reservoir is combined with a comprehensive utilization purpose of improving the water environment, a flood control standard of the reservoir project is designed based on a 20-year return period, and the flood control standard of the reservoir is also verified based on a 200-year return period.
3) a normal storage level, a design flood level, an approval flood level and a total storage capacity of the reservoir are determined based on a local climate, water resource conditions, and water supply and demand balance conditions.
4) in order to reduce erosion of the reservoir caused by natural precipitation and water seepage, it is necessary to plant forests and grasses around the reservoir for covering soil to ensure stability and safety of the reservoir.

The detention reservoir is a way for flood control in China that is widely used in channel water source engineering. A comprehensive utilization reservoir constructed at an appropriate location in an upstream river of a flood control area to be capable of regulating and storing floods, utilizing the reservoir capacity to retain floods for reducing a peak flow entering a downstream river, so as to achieve a purpose of avoiding flood disasters. There are two different ways in which the reservoirs regulate floods, one is for flood detention and the other is for flood storage.

### 1) Flood Detention

The flood detention is that floodwater is temporarily maintained in the reservoir. When there is no gate control arranged on spillways of the reservoir, and an impoundment level of the reservoir is at the same level as an elevation of the spillway crest, the reservoir can only temporarily retain the flood.

### 2) Flood Storage

When there is no gates arranged on the spillway, during a reservoir management and operation stage, if water can be used before a flood season to lower a reservoir water level to a reservoir limit water level, and the reservoir limit water level lower than the elevation of the spillway crest, the storage capacity between the limit water level and the elevation of the spillway crest can play a flood storage role. Some of water stored in the reservoir can be used in a planned manner for economic purposes during a dry season.

When the spillway is equipped with gates, the reservoir can play a greater role for flood storage, and a discharge flow can be adjusted by changing an opening degree of the gates. Because the gates can be controlled, the flood control limit water level of the reservoir can be higher than the spillway crest, and the opening degree of the gates can be adjusted at any time during the flood discharge process to control the discharge flow, which has a dual function of flood detention and flood storage.

### 2. Intercepting Drain

The intercepting drains are of great significance in soil improvement projects, especially in areas with abundant interflow, excavating the intercepting drains is essential. The interflow leads to too much water in the field parcels to form wetlands that are difficult to be constructed, thereby resulting in problems of presenting soil reducibility, decreasing soil microbial activity and causing secondary salinization, which worsens a growth environment of crops and affects growth of the crops. Firstly, excavating an intercepting drain at a position parallel to a lower ridge of each level of field parcel to collect the interflow within the field parcel, so that excess accumulation water in soil of the field parcel can be quickly drained to conveniently be constructed. Secondly, during the rainy season, it can accelerate the drainage of water from the field parcels, reduce flood disasters, and lead to causing secondary salinization of the soil, and lower a groundwater level in the field parcels to a suitable position for crop growth. Finally, during the drought period, the excess water accumulated in the intercepting drain can be redirected back to the field parcels for irrigating the field parcels, and water resources can be reasonably regulated to effectively alleviate drought conditions.

In response to uneven characteristics of drought and flood of farmlands in the channels during the process of land remediation in the loess channels, a method for regulating farmland irrigation by using non-power interflow in the channel region of the Loess Plateau is provided, a purpose is to establish a permeable intercepting drain at the lower ridge of the terraced field to change the groundwater level of the farmlands and regulate soil moisture of the cultivation layer in the farmlands. A specific implementation is as follows:
1) the intercepting drain should be constructed at the lower ridge of each level of terraced field in the channel region, with an excavation direction parallel to the lower ridge of the terraced field and a consistent length thereof.
2) the intercepting drain is set up in an inverted trapezoidal shape, with an opening width of 150 cm-200 cm, a bottom width of 80 cm-100 cm, and a vertical depth of 100 cm-150 cm, the slopes and the bottom at both sides of the intercepting drain are all made of soil surfaces, rather than needing to perform hardening treatment.
3) the top at both sides of the intercepting drain should be hardened with stones or cement, with a harden width of no less than 30 cm, so as to conveniently walk by farmland cultivators, at the same time, a road surface that is hardened should be 10 cm-15 cm higher than a surface of the field parcel.
4) at least one end of the intercepting drain should be connected to the flood drainage ditch of the channel, and a water gate should be arranged at a connection point between the at least one end of the intercepting drain and the flood drainage ditch of the channel; the water gate is constructed at both ends of the intercepting drain, and water storage and discharge of the intercepting drain can be implemented through opening and closing the water gate.
5) when the water gates at both ends of the intercepting drain are closed, an upper edge of the water gate should be 15 cm-20 cm lower than the surface of the field parcel, which can not only prevent excessive water accumulation in the intercepting drain from flooding the field parcel, but also to some extent, prevent groundwater from seeping out of the earth's surface and flowing out.
6) in order to reduce erosion of the slopes on both sides of the intercepting drain caused by natural precipitation and seepage, wet loving plants such as reeds are planted on both sides and the bottom of the intercepting drain, such ecological ditches can effectively prevent water erosion and filter and absorb nutrients from water body.
7) for the channels of an entire watershed, the above intercepting drain can be set up at the lower ridge of each level of terraced fields.

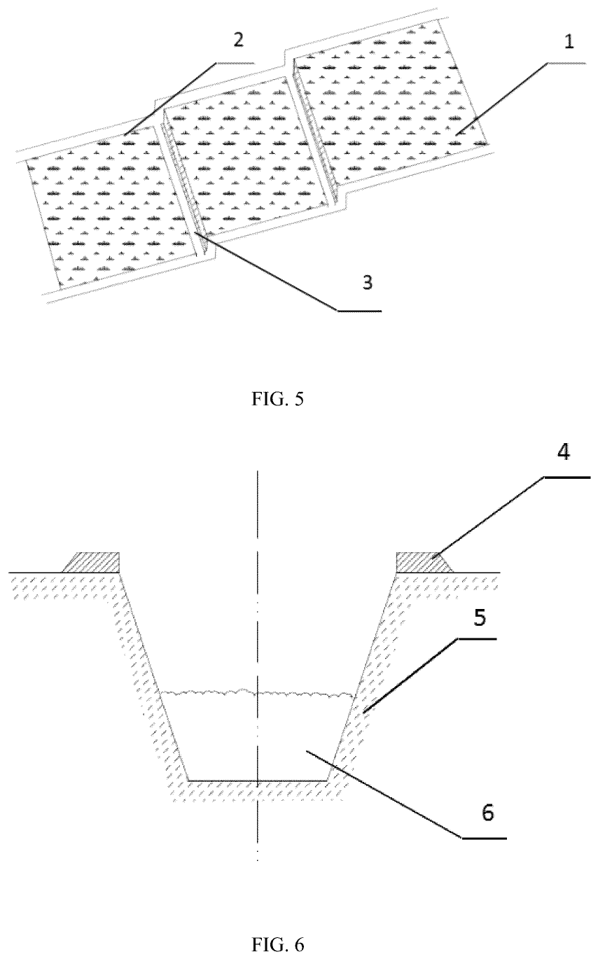

FIG. 5 is a schematic view of a location of the intercepting drain; wherein the element labels shown as below: 1 terraced field, 2 flood drainage ditch, 3 intercepting drain. FIG. 6 is a cross-sectional schematic view of the intercepting drain; wherein the element labels shown as below: 4 hardened roadbed, 5 soil boundary of the intercepting drain, 6 accumulation water in the intercepting drain.

The intercepting drain has the following advantages:
1) un-power irrigation has been achieved, no external power supply (such as electricity) is required, and an adjustment of soil moisture in the cultivation layer of farmlands in the channel region can be achieved by relying solely on regulation of the groundwater level through the intercepting drain.
2) the method is simple, safe and reliable, the intercepting drain has a simple structure and is easy to be constructed; at the same time, according to gradient grades of the terraced fields in the channel region, the intercepting drains can be set up separately, which can reduce risks of erosion and sedimentation to zero and reduce safety hazards.
3) it can effectively prevent the farmlands from being soil salinization, the bottom of the intercepting drain is lower than the groundwater level of the farmland, and accumulation water in the intercepting drain is connected to the groundwater level of the farmland. A drainage function of the intercepting drains can effectively prevent salinity accumulation of the groundwater on the surface due to evaporation of the groundwater.
3. flood drainage ditch: excavating flood drainage ditches at an edge of the farmland near the foot of a hill and a middle of a large field parcel, to intercept mountain torrents and timely drain excess surface water, thereby solving a problem of drainage and soil conservation in the project area.

### 1) Design Standards for Flood Drainage Ditches of Channels

A flood peak flow rate is a basic parameter of a design standard of a flood drainage ditch for gully control and land reclamation. Based on locations of research areas, selecting typical cross-sections within the rivers involved, a principle is to set up the cross-sections at the downstream into where there are larger tributaries imported, circling a corresponding catchment area, and calculating a flood peak flow rate at each cross-section based on the corresponding catchment area. Calculating a peak flood volume of the channel in the research area by using an empirical formula of the flood peak flow rate. Calculation methods for a flood peak flow rate of a small watershed based on measured data include: \textcircled{1} a correlation method of the flood peak flow rate and the catchment area; \textcircled{2} a comprehensive parameter method.

### 2) Construction of Flood Drainage Ditches in the Channels

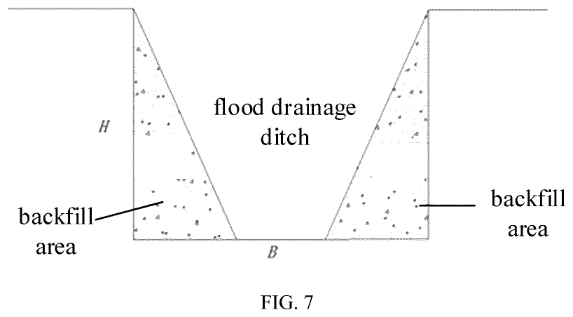

In response to geographical, topographical features, climatic and hydrological characteristics of the project area, in construction of high standard farmlands for gully control and land reclamation, a concept of constructing the flood discharge ditch is proposed in a process of reasonable utilization of water resources; by excavating the flood drainage ditches at the edge of the farmland near the foot of a hill and the middle of the large field parcel, damages to the farmlands caused by heavy rainfall and slope runoff can be avoided. A specific implementation is as follows:
\textcircled{1} the flood drainage ditch should make full use of an original flood drainage ditch surrounded by mountains as much as possible, and if necessary, it can be appropriately renovated. The original mountain flood drainage ditch is formed by years of erosion from mountain torrents, and shapes and bottom plates are relatively stable. Therefore, the original natural ditch should be used as the flood drainage ditch as much as possible. When the original ditch can't meet design requirements and must be renovated, it should be noted that major changes should not be made, and hydraulic conditions of the original mountain flood drainage ditch should not be changed as much as possible. Instead, it is necessary to guide according to situations and ensure smooth discharge.
\textcircled{2} the flood discharge ditch should make the best of slopes of natural terrains, a direction of the flood drainage ditch should follow a vertical direction of most of overland water flows, so that the terrain slope should be fully utilized to enable intercepted mountain flood water to quickly flow into a receiving water body at the shortest distance.
\textcircled{3} whether open canals or closed conduits are used for constructing the flood discharge ditches should be determined based on specific conditions, generally, the open canals are suitable for constructing the flood discharge ditches.
\textcircled{4} determining longitudinal slopes of the flood discharge ditches. The longitudinal slope of the flood drainage ditch should be determined based on terrain, geology, masonry, slopes of original drainage ditches, and erosion and sedimentation conditions, which is generally not less than 1%. When designing the longitudinal slope, it is necessary to uniformly increase a water flow velocity in the flood discharge ditch to prevent sedimentation in the flood discharge ditch. When the longitudinal slope is large, it should consider to setting up hydraulic drops or chutes, which should not be arranged at turns of the flood discharge ditch. A height of a single hydraulic drop is usually 0.2 m˜0.6 m and some can reach up to 20˜30 levels, which has a good energy dissipation effect thereof. The chute, also known as a rapid flow groove, has a longitudinal slope of generally 20% to 60%, which is often built with rubbles, block stones or strip stones, and some are poured with reinforced concrete. A power dissipation device should be installed at a terminal of the chute.
\textcircled{5} a cross-sectional form of the flood drainage ditch. A width of a cross-section of the flood drainage ditch varies depending on an amount of rainfall flow. A cross-section of the flood discharge open canal is commonly rectangular or trapezoidal, referring to FIG. 7, a minimum cross-section of the flood discharge ditch is of B×H=0.4 m×0.4 m. A material and a reinforcement form of the flood discharge ditch should be determined based on the maximum flow velocity of the flood discharge ditch, a local terrain and geological conditions and a local material supply. Soil and grouted rubble are commonly used to construct the flood discharge ditch.

The flood drainage ditch is used for drainage of the project area to protect normal growth of crops and safety of the field parcels. Advantages of above designs of the flood discharge ditch are:
\textcircled{1} an integrated design has been achieved with projects of irrigation and drainage canals, reservoirs (reservoirs) and intercepting drains. It does not need for an external power supply (such as electricity), relying solely on the flood drainage ditches to regulate excessive precipitation and interflow.
\textcircled{2} the design of the flood discharge ditch is simple, safe, reliable, and easy to be implemented. Based on the channel of the original mountain flood discharge ditch, making appropriate modifications and setting up the flood discharge ditches can minimize safety hazards.
\textcircled{3} it can effectively prevent water accumulation from being occurred in soil of the farmlands. A flood discharge function of the flood drainage ditch can effectively prevent impact of soil erosion on the field parcels and a large amount of water accumulation in the field parcels, to ensure safety of the farmlands.
4. dual-purpose irrigation and drainage canal

### 1) Design of Irrigation and Drainage Canal

In order to meet a water demand for cultivation in the project area, by on-site investigation and visits, combined with local climate regulation and water resource conditions, the water source is connected to the project area in a form of lateral canals, field ditches or pipelines. A practical dual-purpose irrigation and drainage canal is set up in rice field areas to ensure irrigation and drainage of various crops in the project area.
a lateral canal of the dual-purpose irrigation and drainage canal is subjected to perform continuous irrigation, and a design flow rate is calculated according to an equation (2):

$$Q = {q}_{s} \cdot {A}_{S} \qquad ( 2 )$$

wherein in the equation (2), Q is a design flow rate of a trunk canal (m³/s), qₛ is a design irrigation modulus, and Aₛ is an irrigation area controlled by the trunk canal (hm²). qₛ is 0.06 m³/s.
a design flow rate of a field ditch of the dual-purpose irrigation and drainage canal is calculated according to an equation (3):

$$Q = amAN / 86400 \cdot T \cdot η \qquad ( 3 )$$

wherein in the equation (3), Q represents the design flow rate of the field ditch (m³/s), a represents a proportion of a crop planting area (%), m represents an irrigation quota required for a critical growth period of crops (m³/mu), A represents an irrigation area controlled by the field ditch (mu), N represents a number of irrigation groups of the field ditch, T represents a duration time of performing crop irrigation, and n represents a water utilization coefficient of the field ditch.

A main crop in the project area is corn, with a planting area ratio of 90%; according to a crop irrigation system in the project area, an irrigation quota for corn is 40 m³/mu; n=0.90.

### 2) Construction of Irrigation and Drainage Canal

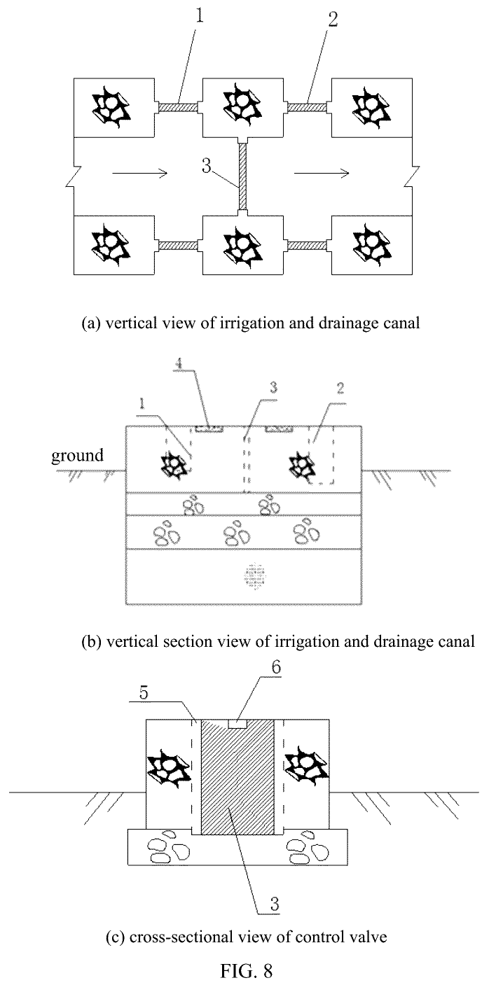

In order to meet irrigation and drainage requirements of paddy fields, it aims to create a unique landscape of paddy fields in Nanniwan, while also conserving lands of the canals. Based on on-site measurements, planting experiences and construction conditions in the project area, the dual-purpose irrigation and drainage canal is set up in the project area to meet irrigation and drainage needs. The dual-purpose irrigation and drainage canal is arranged vertical to the field ditch, with a width of 1.2 m at the bottom of the canal, performing foundation treatment such as gravel backfilling, stone throwing foundation and stone throwing grouting on the bottom of the canal. A cross-sectional specification of a canal flow is 0.4×0.6 m, which is built with 30 cm thick mortar masonry blocks; every 50 cm on the top surface of the canal, C20 prefabricated cover plates with a cross-sectional specification of 1×0.3×0.05 m are laid across the canal to facilitate agricultural transportation and beautify the rice field landscape. Reserving a set of irrigation valves every 50 m in the canal, including two inlet valves, two outlet valves and a water control valve, to facilitate irrigation and drainage. As shown in FIG. 8, (a) is a top view of the irrigation and drainage canal, (b) is a longitudinal cross-sectional view of the irrigation and drainage canal, and (c) is a cross-sectional view of the water control valve; wherein the element labels shown as below: 1 inlet gate, 2 outlet gate, 3 regulating gate, 4 steel concrete cover plate, 5 angle steel, 6 valve pulling ring.

According to soil moisture and crop water requirements, it can be divided into a water demand period and a drainage period. When the crops are in the water demand period, water is conducted from the lateral canal or the field ditch to the dual-purpose irrigation and drainage canal, a circulating irrigation is performed on the crops, the inlet valves and the outlet valves arranged on the upstream of the field parcels to be irrigated are closed, as well as water control valves adjacent to the downstream of the field parcels, while inlet valves adjacent to the field parcels to be irrigated are opened for performing irrigation. After the irrigation is completed, a corresponding mode is performed on a next field parcel to be irrigated; when it needs to perform farmland drainage, closing all the inlet valves and the control valves, and opening the outlet valves to perform rice field drainage.

During the irrigation process, the dual-purpose irrigation and drainage canal is used to perform section rotational irrigation. Closing water control valves of a first set of water distribution devices, and opening water inlets on both sides of the first set of water distribution devices to irrigate the paddy fields on both sides of the irrigation and drainage canal. After the two paddy fields is completely irrigated, opening the water control valves of a next set of water distribution devices and the water inlets on both sides thereof, at the same time, closing a previous set of water inlets to perform irrigation on the next field parcel. Such irrigation mode is performed in sequence until all field parcels are completely irrigated. The outlet gate is always closed during the irrigation process. During the drainage process, all the water control valves and the outlet gates are opened to allow excess accumulation water in the field parcels to be discharged from the outlets into the dual-purpose irrigation and drainage canals and then being discharged out.

Because the dual-use irrigation and drainage canal is generally arranged in a middle of the farmland, when there are inlet gates and outlet gates arranged on both sides of the canal, the farmlands on both sides of the canal can be irrigated separately. A lower end of the inlet gate is flush with the farmland, while a lower end of the outlet gate is lower than the farmland, which can easily perform drainage operations on the farmland. A set of water distribution devices is arranged every 10 to 70 meters in the canal, which specifically depends on a distance between each two adjacent farmlands. Reinforced concrete cover plates are laid every 0.3 m-0.8 m on the canal, which not only meets needs of tourists for sightseeing and transportation from the middle of the farmlands, but also serves as a corridor for biological life in the field parcels on both sides of the canal. The dual-purpose irrigation and drainage canals have the following advantages:
\textcircled{1} the irrigation canals and the drainage canals of the paddy fields are integrated, compared to a conventional irrigation canal and a conventional drainage canal separated with each other, which can save project costs and reduce land areas.
\textcircled{2} manually controlling switches of valves to regulate irrigation and drainage of different field parcels, which has a simple operation without needing to excavate temporary drainage canals.
\textcircled{3} the dual-purpose irrigation and drainage canal not only meets the needs of tourists walking and sightseeing from the middle of the paddy fields, but also connects the field organisms on both sides of the dual-purpose irrigation and drainage canal through the cover plate being arranged on the irrigation and drainage canal, which plays a corridor role for biological life of the field parcels.

### 5. Comprehensive Control Technology of Non-Power Irrigation for Gully Interflow

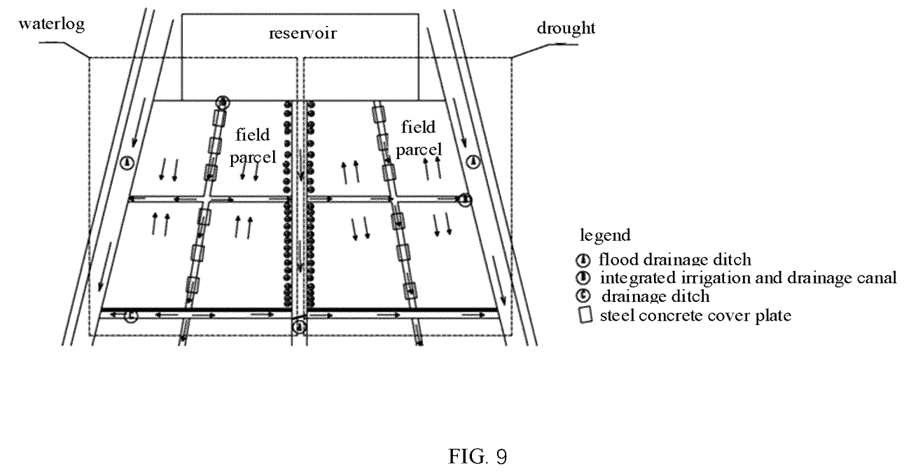

The comprehensive control technology of non-power regulation irrigation for interflow in the loess plateau channel is based on a formation mechanism of interflow, and based on the soil body reconstruction of gully control and land reclamation, it integrates irrigation and drainage measures such as retention reservoirs, flood discharge ditches, intercepting drains and dual-purpose irrigation and drainage canals of the channels to achieve non-power regulation and utilization of surface water, soil water and groundwater resources in the canals. A “drought irrigation, flood drainage” of water resource non-power regulation irrigation engineering mode for canals is constructed, which improves efficiency of water resource utilization. At the same time, the construction and application of the comprehensive irrigation system can not only achieve timely adjustment of soil moisture in the farmlands of gully control and land reclamation, but also protect the farmlands in the canals from being soil erosion disasters such as floods, droughts and mudslides. In addition, combining layouts of the field roads, planting farmland protective forests and laying life corridors of the canals, it not only improves quality of the farmlands in the canals, but also protects a regional ecological environment thereof. FIG. 9 is an operation schematic view of the water and soil resource comprehensive improvement method for loess hilly and gully region channels; wherein the element labels shown as below: [symbol] flood drainage ditch, [symbol] integrated irrigation and drainage canal, [symbol] intercepting drain, [symbol] steel concrete cover plate.

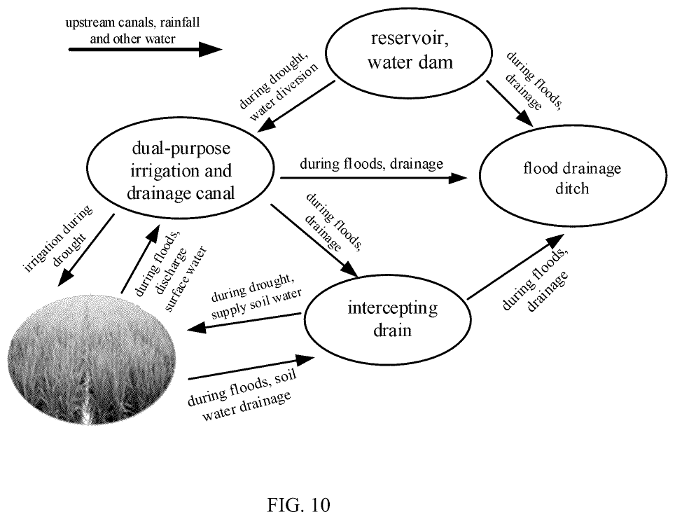

FIG. 10 is a schematic view of a comprehensive regulation and control operation mode of a non-power regulation irrigation. Referring to FIG. 10, it is affected by confluences of precipitation from mountains in the canals, natural precipitation causes an increase of a soil moisture content for gully control and land reclamation, so that the farmlands is susceptible by flood disasters. By using the comprehensive regulation system, the detention reservoir can effectively buffer the impact of channel confluence that is occurred on the farmlands, while also serving as a reservoir and storage for water resources. When the rainfall exceeds a water storage warning, a water control gate of the flood drainage ditch can be opened to discharge excess water. At the same time, the accumulation water in the farmlands can be quickly conducted into the flood drainage ditch through the intercepting drain and the dual-purpose irrigation and drainage canal, which can reduce impact of excessive accumulation water that is occurred on crop growth in a timely manner. In addition, the groundwater level in the area increases after precipitation, which can easily cause salinization of the farmlands, by constructing the intercepting drain, not only the field water can be timely diverted and discharged into the flood drainage ditch through the intercepting drain, but also the groundwater level can be lowered to prevent a risk of soil salinization.

When the field parcel of gully control and land reclamation is dry, according to a gradient of the field parcel, the water control gates of the flood drainage ditch are gradually closed, the valves of the reservoir are opened, and the water stored in the reservoir enters the flood drainage ditch. As the water level in the flood drainage ditch rises and is affected by a water potential difference, the accumulation water in the flood drainage ditch will enter the dual-purpose irrigation and drainage canal, and then ultimately enter the field parcels. At the same time, a rising water level in the flood drainage ditch can also be conducted into the intercepting drain, to increase the groundwater level through soil seepage, which not only plays a role for fully irrigating roots of crops, but also alleviates a rapid leakage of open water irrigation, quickly alleviates drought, and improves efficiency of water resource utilization.

In the channel regions of the Loess Plateau, surface runoff and interflow often occur simultaneously, which are mostly caused by rainfall. So in the channel regions of the Loess Plateau, an essence of an interflow control system is to scientifically regulate a movement mode and a process of rainfall on the earth's surface and soil, and optimize a combination of runoff, storage and drainage engineering. An operation of the comprehensive regulation control system for non-power interflow is:
1) the regulation control system for interflow should combine interception and diversion, accumulation and storage, and supply and water conservation to weaken an erosion force of water flows to achieve a purpose of reducing soil erosion. 2) the regulation control system is configured to excessively concentrate water resources that are dispersed within a certain area and reasonably improve the efficiency of water resource utilization. 3) the regulation control system is configured to improve soil nutrients to some extent and avoid loss of soil nutrients. 4) by regulating interflow, a probability of natural disasters such as landslides and collapses can be effectively reduced.

The embodiment of the present disclosure can appropriately merge into the field parcels that are irregular and have small areas and are non-conducive to be mechanically cultivated, so as to achieve a basic balance of soil excavation and filling within a small region range; a slope of about 10° is set in vertical and horizontal directions of the strip field to prevent soil erosion and ensure a minimum amount work for performing land leveling. In areas where the soil layer thickness is insufficient or uneven, measures should be taken to remove topsoil or guest soil, and then perform land leveling to increase an effective soil layer thickness and reduce the slope of the field parcel, to control a height difference of the field surface in the field parcels. After land improvement in the project area of Yangwangou in Nanniwan Town is completed, the soil layer thickness of the cultivation layer in the paddy field is greater than 30 cm, and the height difference of each field surface in each field parcel is controlled within ±3 cm; the effective soil layer thickness in the non-irrigated land is greater than 50 cm, and the slope of the field surface is not more than 5%. A length of the field parcel in the strip field is greater than 100 m, and a width is greater than 50 m. A width of the terraced field with a gentle slope below 5° is greater than 30 m, a width of the terraced field with a steep slope of 5°-15° is greater than 10 m, and a width of the terraced field with a steep slope of 15°-25° is greater than 8 m. The length of the field parcel is divided according to actual situations, in order to conveniently farm by machines and production for villagers, so that a standard length of the field parcel is greater than 50 m.

By combining soil testing and fertilization formulas, identifying indicators of soil nutrient abundance and deficiency, and adopting a comprehensive rapid fertilization technology of “soil diagnosis+organic and inorganic fertilizers+trace elements+microbial agents”, applying organic materials such as sheep manure and pig manure with high organic matter contents; combined application of fertilizers containing large amounts of elements such as nitrogen, phosphorus and potassium, as well as trace elements such as calcium and magnesium; appropriately using straw, green manure returning to the field, and coal based microbial agents for reconstructing soil body nutrient improvement, supplementing required nutrients according to main growth periods of crops, during a tillering stage of rice, nitrogen is a main fertilizer, combined with phosphorus and potassium fertilizers; during a booting stage, potassium is a main fertilizer, supplemented with nitrogen and phosphorus, to improve soil ripening and soil fertility according to local conditions. After the soil nutrition reconstruction is completed, an average pH value of a test soil sample with a 0-30 cm cultivation layer in the Yangwangou project area is 8.4, an average electrical conductivity value is 0.220 dS·m⁻¹, an average effective phosphorus content is 4.35 mg·kg⁻¹, an average total nitrogen content is 1.01 mg·kg⁻¹, an average organic matter content is 8.42 g·kg⁻¹, an average available potassium content is 151.54 mg·kg⁻¹, and a texture type is consistent, all of which are sandy loam soil. Based on an actual situation of the local area and according to a stipulation on the “Quality Standards for Newly Added Farmland in the Loess Plateau Area of Northern Shaanxi Province” in the [symbol] Quality Standards for Newly Added Farmland in the Land Improvement Project of Shaanxi Province (Trial) [symbol] , a pH value in a standard range for a physical indicator is 8.0±0.5, an electrical conductivity ≤2 dS·m⁻¹, an effective phosphorus content in a standard range of a nutrient indicator is ≥2 mg·kg⁻¹, a total nitrogen content ≥0.5 mg·kg⁻¹, an organic matter content ≥5 g·kg⁻¹, and an available potassium content ≥50 mg·kg⁻¹. Both the nutrient indicator and the physical indicator meet improvement requirements for soil in gully land remediation. Based on the soil body reconstruction in the channels, interception, storage, irrigation and drainage technologies such as intercepting drains, reservoirs, dual-purpose irrigation and drainage canals and flood discharge ditches are adopted, a “drought irrigation, flood drainage” of water resource non-power regulation irrigation engineering mode for canals is constructed, the water resources in the canals are effectively regulated, a non-power regulation and utilization of interflow in the canals has been achieved, thereby improving the efficiency of water resource utilization in the canal. An irrigation guarantee rate of farmlands in the channel has reached over 75%, a water utilization coefficient of a channel system has been increased from less than 0.5 to 0.7, and an irrigation water utilization coefficient has been increased from 0.45 to 0.65. An oxidation-reduction potential of a soil surface of 0-20 cm is increased from −120-40 mV to 150-300 mV, and a content of reducing ferrous ions is decreased from 17.9-50.5 mg/kg to 3.8-26.3 mg/kg, which improves an oxidation-reduction status of soil in the farmland of the channel, and a water-soluble salt content of soil in the farmland is reduced to below 1 g/kg, thereby effectively reducing risks of soil salinization, improving soil microbial activity, increasing self-repair function and buffering capacity of soil.

After the soil profile reconstruction, the biological nutrient reconstruction, and the water resource comprehensive regulation, the land improvement project area of Yangwangou has ensured mechanized cultivation, while an irrigation land area is increased from 11.11 hm² to 12.38 hm², and a non-irrigated land area is increased from 207.88 hm² to 209.09 hm². A crop yield of newly cultivation lands is also significantly increased, a grain yield per hectare is increased from 9000 kg to 10500 kg, and a grain yield increase rate reaches 16.67%. Ultimately, a quality level of low productivity or unproductive farmlands in the channels is raised to a 11-th level, which is one level higher than a quality level of surrounding farmlands. An amount of soil erosion in the channels is decreased from 133.78 t/(hm²·a) to below 90.46 t/(hm²·a), thereby optimizing the ecological effect of gully control and land reclamation, effectively ensuring an ecological environment safety of the channels, and achieving a comprehensive improvement of water and soil resources for loess hilly and gully region channels.

As mentioned above, the present disclosure can be effectively implemented. The above embodiments only describe preferred embodiments of the present disclosure and are not intended to limit the scope of the present disclosure. Any variation or replacement made by one of ordinary skill in the related art without departing from the spirit of the present disclosure shall fall within the protection scope of the present disclosure.

1. A water and soil resource comprehensive improvement method for loess hilly and gully region channels comprising:
(1) soil layer general survey: performing soil layer thickness survey and soil nutrition content measurement;
(2) soil body reconstruction: on the basis of soil layer general survey data, selecting a soil body construction mode, and performing soil body profile reconstruction, soil body nutrition reconstruction and field parcel arrangement; and
(3) constructing a water resource regulation and control system for the loess hilly and gully region channels.

2. The water and soil resource comprehensive improvement method for loess hilly and gully region channels as claimed in claim 1, wherein the step of performing the soil layer thickness survey comprises: measuring the soil layer thickness of a typical area in areas to be rectified, forming a calibration equation, and then measuring the soil layer thickness of other areas, and using the calibration equation for calibration.

3. The water and soil resource comprehensive improvement method for loess hilly and gully region channels as claimed in claim 1, wherein the step of selecting the soil body construction mode is based on a comparison between a minimum value of the soil layer thickness that is measured at each detection point in the areas to be rectified and a maximum elevation difference between each of detection points, to select a corresponding soil body construction mode; and wherein
the corresponding soil body construction mode is selected from one of the following modes:
(1) if the maximum elevation difference between each of the detection points in the areas to be rectified is less than the minimum value of the soil layer thickness that is measured at each detection point, performing the soil layer thickness reconstruction and land leveling on rectification areas directly; wherein the soil layer thickness isn't less than 30 cm, and a slope ratio is less than or equal to 5/1000;
(2) if the maximum elevation difference between each of the detection points in the areas to be rectified is greater than the minimum value of the soil layer thickness that is measured at each detection point, under a principle of performing excavation and filling on earthwork balance, stripping topsoil and then placing the topsoil that has been stripped in a centralized manner, after the soil leveling meets a specification, backfilling the topsoil according to a design elevation, optimizing the soil layer thickness and a slope; wherein the slope ratio of the land that has been rectified is less than or equal to 5/1000, and the soil layer thickness is 50-80 cm; and
(3) if the elevation difference between each of the detection points in the areas to be rectified is greater than 4 m or the soil layer thickness of the detection points is lower than the elevation difference of a small number of detection points, based on a detection result of the soil layer thickness in an early stage, performing field parcel distribution on the area that has been rectified, with a principle of facilitating mechanical cultivation and increasing an effective cultivation land area, based on terrain and topography, planning to shape the field parcels to be approximately regular squares to ensure engineering requirements of a construction thickness and the slope, as well as growth needs of crops.

4. The water and soil resource comprehensive improvement method for loess hilly and gully region channels as claimed in claim 1, wherein the step of performing the soil body profile reconstruction is performing thickness remediation on the areas with uneven soil thickness in the field parcels; the step of performing the soil body nutrition reconstruction comprising: detecting a soil nutrient index content of a cultivation layer, clarifying soil nutrient deficiency indicators, calculating a soil nutrient application amount of the cultivation layer, ensuring that the cultivation layer meets requirements of soil nutrient quality control, or performing improvement of the soil body nutrient reconstruction.

5. The water and soil resource comprehensive improvement method for loess hilly and gully region channels as claimed in claim 4, wherein calculation of the soil nutrient application amount of the cultivation layer is shown in equation (1):
$$Y = ( X \times M - S \times 2.25 \times T ) / F ; \qquad ( 1 )$$
wherein in the equation (1),
Y is the nutrient application amount, kg/hm²;
X is a nutrient absorption per unit yield of crops, kg/100 kg;
M is a target yield, 100 kg/hm²;
S is a measured value of the soil nutrient content, mg/kg;
2.25 is a conversion coefficient for converting soil nutrient of the cultivation layer to 1 hm² of soil nutrient content;
T is a correction coefficient, that is, a soil nutrient utilization efficiency; and
F is a seasonal utilization rate of nutrients.

6. The water and soil resource comprehensive improvement method for loess hilly and gully region channels as claimed in claim 4, wherein requirements for various nutrient indicators of the cultivation layer soil are as follows: an organic matter/(g/kg)≥5, a total nitrogen/(g/kg)≥0.5, an alkali hydrolyzed nitrogen/(mg/kg)≥60, an available phosphorus/(mg/kg)≥2, and an available potassium/(mg/kg)≥50.

7. The water and soil resource comprehensive improvement method for loess hilly and gully region channels as claimed in claim 1, wherein the step of performing field parcel arrangement comprises: land leveling units are divided into two types of strip fields and terraced fields, the trip fields comprising paddy fields;
wherein each control area of the strip field is 0.25 hm²-1.00 hm² to conveniently be cultivated by large machinery equipments; the terraced fields are built on sloping farmlands below a slope of 15°, with an area of each terraced field being controlled between 0.15 hm²-3.50 hm², and a minimum area of the terraced field is not less than 0.03 hm²;
the soil layer thickness of the cultivation field parcels in the terraced fields greater than 30 cm; after the cultivation field parcel within the terraced fields is leveled, retaining about 1 meter away from an edge of the field, and a reverse slope of 10° to obtain a high outside and a low inside thereof; and
the cultivation field parcels of the paddy fields are internally arranged with grid fields, with a length of 30 m-120 m and a width of 20 m-40 m; a field ridge bounded between the grid fields, with a height of 30 cm and a width of 20 cm at the top of the field ridge; a height difference of an inner field surface in the grid field less than ±3 cm, and the soil layer thickness greater than 50 cm.

8. The water and soil resource comprehensive improvement method for loess hilly and gully region channels as claimed in claim 1, wherein the water resource regulation and control system comprises constructing a detention reservoir, an intercepting drain, a flood discharge ditch and a dual-purpose irrigation and drainage canal; the detention reservoir configured to divert water into the dual-purpose irrigation and drainage canal, the intercepting drain configured to replenish water for soil to meet agricultural water needs during drought; water from the detention reservoir discharged into a flood discharge ditch, the water from the dual-purpose irrigation and drainage canal discharged into the intercepting drain, and the water from the intercepting drain discharged into the flood discharge ditch to lower a groundwater level during flooding.

9. The water and soil resource comprehensive improvement method for loess hilly and gully region channels as claimed in claim 8, wherein a lateral canal of the dual-purpose irrigation and drainage canal is subjected to perform continuous irrigation, and a design flow rate is calculated according to an equation (2):
$$Q = {q}_{s} \cdot {A}_{S} \qquad ( 2 )$$
wherein in the equation (2), Q is a design flow rate of a trunk canal (m³/s), qₛ is a design irrigation modulus, and Aₛ is an irrigation area controlled by the trunk canal (hm²); and wherein
a design flow rate of a field ditch of the dual-purpose irrigation and drainage canal is calculated according to an equation (3):
$$Q = amAN / 86400 \cdot T \cdot η \qquad ( 3 )$$
wherein in the equation (3), Q represents the design flow rate of the field ditch (m³/s), a represents a proportion of a crop planting area (%), m represents an irrigation quota required for a critical growth period of crops (m³/mu), A represents an irrigation area controlled by the field ditch (mu), N represents a number of irrigation groups of the field ditch, T represents a duration time of performing crop irrigation, and n represents a water utilization coefficient of the field ditch.

10. The water and soil resource comprehensive improvement method for loess hilly and gully region channels as claimed in claim 1 is applied to an application of ecological management of loess hilly and gully regions, wherein the ecological management comprises: increasing areas of irrigated lands, areas of non-irrigated lands, farmland quality and a grain yield, preventing and controlling soil salinization and reducing a soil erosion amount.
